(19) United States
(12) Patent Application Publication
(10) Pub. No.: US 2014/0295366 A1
(43) Pub. Date: Oct. 2, 2014

(54) PREPARATION OF AN ELECTRODE-ACTIVE MATERIAL BY USING A DOUBLE-PIPE TYPE HEAT EXCHANGER

(71) Applicant: HANWHA CHEMICAL CORPORATION, Seoul (KR)

(72) Inventors: Kyu Ho Song, Daejeon (KR); Sei Ung Park, Daejeon (KR); Seong Jae Lim, Daejeon (KR); Ki Taeg Jung, Daejeon (KR); Kee Do Han, Daejeon (KR)

(73) Assignee: HANWHA CHEMICAL CORPORATION, Seoul (KR)

(21) Appl. No.: 13/885,584

(22) PCT Filed: Dec. 10, 2012
(86) PCT No.: PCT/KR2012/010686

§ 371 Date: May 15, 2013

(30) Foreign Application Priority Data
Dec. 20, 2011 (KR) 10-2011-0138286

(51) Int. Cl. H01M 4/04

(52) U.S. Cl. CPC H01M 4/0471
USPC 432/9; 432/77

(57) ABSTRACT

Preparation of an electrode-active material, which uses a reactor to produce an electrode-active material by using a supercritical hydrothermal synthesis method, and a double-pipe type heat exchanger which cools the product discharged from the reactor to a subcritical range or below it.

### TECHNICAL FIELD

The present invention relates to an apparatus and a method for preparing an electrode-active material by using a double-pipe type heat exchanger and a super-critical hydrothermal synthesis method.

### BACKGROUND ART

Electrode-active materials can be prepared in various ways. As preparation methods for electrode-active materials of secondary batteries, a solid state method, a co-precipitation method, a hydrothermal method, a supercritical hydrothermal method, a sol-gel method, and an alkoxide method, etc. are used.

In the case of a cathode-active material of a lithium secondary battery, a supercritical hydrothermal synthesis method is advantageous in that it can highly improve the crystallinity of particles while making the average size of primary particles be in the range of tens or hundreds of nano meters.

With respect to supercritical hydrothermal synthesis methods, many studies are being conducted so as to establish the mixing and reacting conditions of reactants. Various studies are also being conducted on the crystallinity of particles. However, studies on continuous-type preparation processes of cathode-active materials for secondary batteries which adopt a supercritical hydrothermal synthesis method are few in number: only some studies are in progress and they are directed to methods of mixing and inputting reactants.

Although continuous-type supercritical hydrothermal synthesis methods have many advantages, they have problems of reducing process stability.

Specifically, when a cathode-active material of a lithium secondary battery is prepared by using a continuous-type supercritical hydrothermal synthesis method, the fluid in a supercritical state has a low density and a low viscosity (for example, water in a super critical state has ¼-⅙ of the density of water at room temperature). As a result, solid particles contained in the fluid precipitate in the pipes of the apparatus, causing plugging which hinders the smooth flow of the fluid. In particular, at a dead zone of a pipe which is the passageway of a fluid, back flow or eddies occur, and solid particles contained in the fluid precipitate and accumulate. Further, if the fluid does not have proper turbulent flow characteristics, there occurs a scaling phenomenon wherein ions or micro particles deposit on the wall surfaces of the passage due to differences in the density and viscosity of the particles and the fluid, resulting in the deposition of solid particles in the apparatus.

Plugging increases pressure in a cathode-active material preparation process, making impossible the continuous operation of the process and thus necessitating stoppage, maintenance, and repair of the process. Frequent starts and stops of the process shorten the service life of the facility while increasing maintenance and repair costs, making continuous preparation difficult, and thus increasing the costs of process operation, raw materials, and the facility, and increasing the unit cost of product manufacture. Also, frequent starts and stops of the process may deteriorate the crystallinity of primary particles. In addition, plugging may rapidly increase the pressure in the apparatus, thereby increasing the risk for accidents.

Therefore, it is necessary to prevent plugging in the apparatus when preparing an electrode-active material using a continuous-type supercritical hydrothermal synthesis method.

### DISCLOSURE OF INVENTION

### Technical Problem

It is an object of the present invention to decrease the occurrences of plugging and scaling in a continuous process for preparing an electrode-active material by using a supercritical hydrothermal synthesis method.

### Solution to Problem

The present invention provides an apparatus for preparing an electrode-active material, comprising: a reactor which produces an electrode-active material by using a supercritical hydrothermal synthesis method; and a double-pipe type heat exchanger which cools the product discharged from the reactor to a subcritical range or below it.

The present invention provides a method for continuously preparing an electrode-active material, comprising: forming an electrode-active material by using a super-critical hydrothermal synthesis method; and cooling a fluid containing the electrode-active material to the subcritical range or below it, by using a double-pipe type heat exchanger.

### Advantageous Effects of Invention

If an electrode-active material is continuously prepared according to the present invention, plugging and scaling can be suppressed in the course of the process, enabling a stable and continuous process operation, decreasing the maintenance cost of the process, and extending the service life of the process facility. In addition, the electrode-active material manufactured by the present invention has an increased crystallinity of particles, and thus can prolong the service life of batteries.

### BRIEF DESCRIPTION OF DRAWINGS

FIG. 1 illustrates an example which shows a sharp change in the inner diameter of the pipe (the inclination angle θ of the inner surface is 90°).

FIG. 2 illustrates an example wherein the inner diameter of the pipe remains unchanged.

FIG. 3 illustrates an example which shows a slow change in the inner diameter of the pipe (the inclination angle θ of the inner surface is about 150°).

FIG. 4(a) is a photo showing an example where plugging occurred in the pipe. FIG. 4(b) is a photo showing an example where plugging did not occur in the pipe.

FIG. 5(a) is a graph showing changes in the density of water depending on the change of temperature at a pressure of 250 bars. FIG. 5(b) is a graph showing changes in the viscosity of water depending on the change of temperature at a pressure of 250 bars.

FIG. 6 illustrates a process for preparing an electrode-active material according to an embodiment of the present invention.

### MODE FOR THE INVENTION

The present invention provides an apparatus, comprising a reactor which generates an electrode-active material by using a supercritical hydrothermal synthesis method and by cooling the product discharged from the reactor to the subcritical range or below it by using a double-pipe type heat exchanger.

According to the present invention, after the time when the raw materials of the electrode-active materials react under a supercritical environment until the time the reaction products move out of the subcritical region by passing through subsequent steps, the inner diameter of the pipes provided in the apparatus does not change beyond a certain degree.

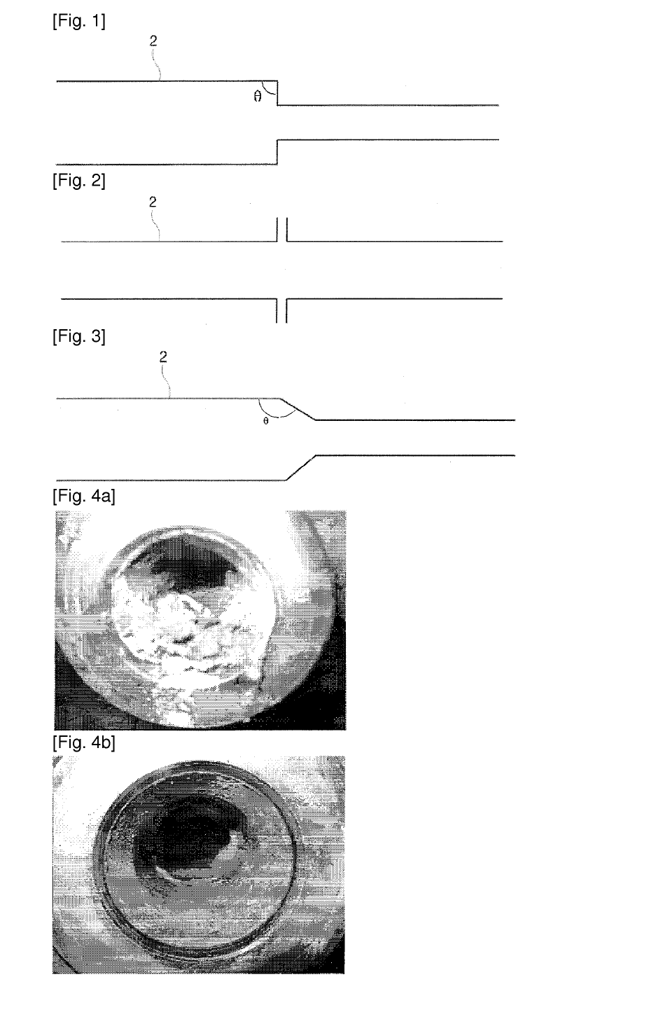

FIGS. 1, 2 and 3 illustrate examples where the inclination angles θ of the inner surfaces of the pipes are different from each other.

The pipes of the section from the reactor to the double-pipe type heat exchanger can be those whose inclination angle θ of the inner surface is 110° or greater. Preferably the angle θ is 140° or greater. Most preferably, the inner diameter of the pipes does not vary.

If the angle θ is as above, the fluid flowing inside the pipes does not generate backflows or eddies. If a pipe has a portion where its inner diameter abruptly changes, plugging can easily occur and hinders fluid flow.

It is preferred that the fluid passing through the double-pipe type heat exchanger flow in the direction of gravity.

The present invention provides a method for continuously preparing an electrode-active material, which comprises a step for forming an electrode-active material by using a supercritical hydrothermal synthesis method, and a step for cooling the fluid containing the electrode-active material to the subcritical range or below it by using a double-pipe type heat exchanger.

An example of the continuous supercritical hydrothermal synthesis method of the present invention includes: a step of mixing water and raw materials for a cathode-active material in a reactor and forming a slurry wherein the cathode-active electrode material or a precursor of the cathode-active material is included in a fluid; and a step of introducing the slurry into a reactor having a reaction temperature of 375-450° C. and a reaction pressure of 230˜300 bars and synthesizing or crystallizing the cathode-active material.

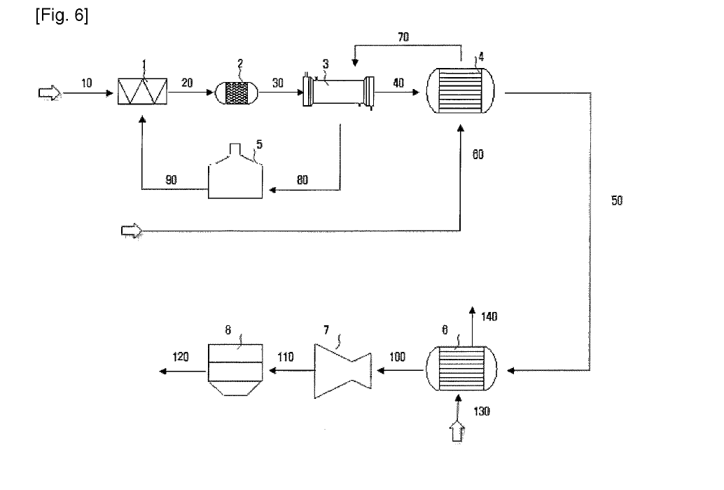

FIG. 6 illustrates an example of an apparatus for preparing an electrode-active material by using a continuous-type supercritical hydrothermal synthesis method of the present invention. The apparatus comprises a mixer 1, a reactor 2, coolers 3, 4 and 6, a decompressor 7, and a concentrator 8.

Raw materials of a cathode-active material are supplied to the mixer 1 through a passage 10. The mixer 1 mixes the raw materials and produces the cathode-active material and/or a precursor of the cathode-active material and discharges them through a passage 20. The mixer 1 may have a region where fluid changes from a liquid phase to a supercritical state and a region of a supercritical state.

In the reactor 2, a cathode-active material is synthesized or the primary particles of the cathode-active material are crystallized and discharged through a passage 30. The fluid in the reactor 2 remains in a supercritical state.

In the present invention, water, which is a fluid, can have a temperature of 375-450° C. and a pressure of 230-300 bars at its supercritical state, and its subcritical state can have a temperature of 350-373° C.

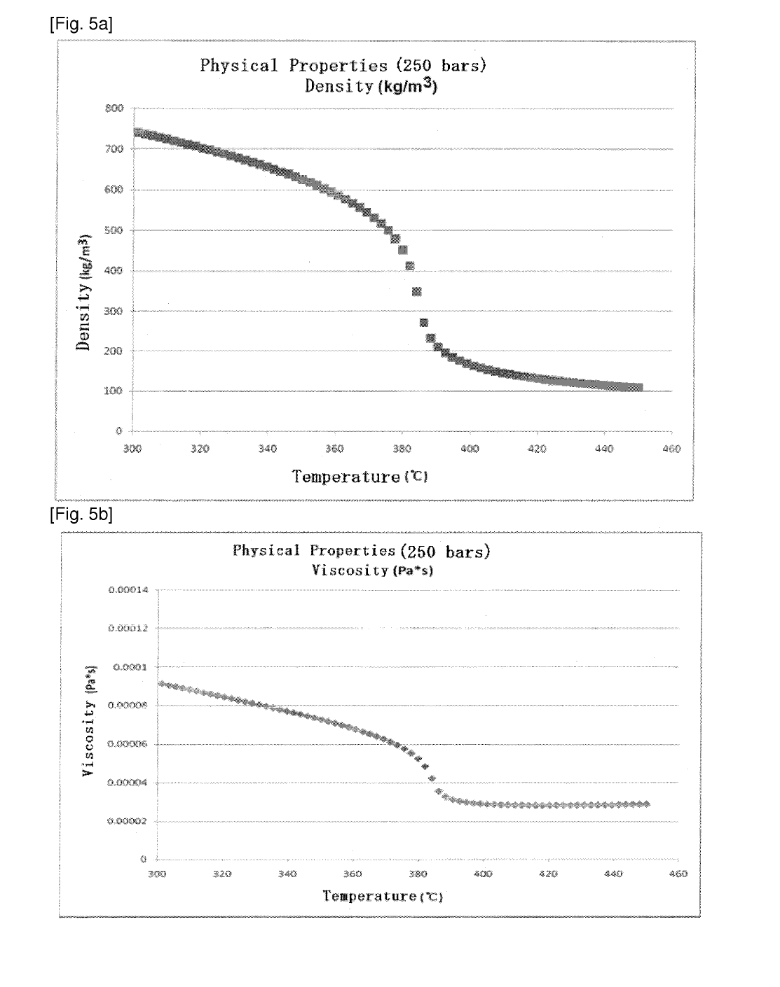

FIGS. 5(a) and 5(b) respectively show changes in the density and viscosity of water depending on the change of temperature when pressure is 250 bars. They show regions where the density and viscosity change sharply.

Heat exchangers 3, 4 and 5 are placed behind the reactor 2 and cool the fluid containing the cathode-active material from the supercritical state to the liquid phase state. The cooling may be carried out through multiple stages using a plurality of heat exchangers. The heat exchanger 3 positioned closest to the reactor 2 among the multiple heat exchangers cools the fluid of the supercritical state to the subcritical state of below 374° C. or to the liquid phase. Preferably, the cooler 3 is a double-pipe type heat exchanger.

A furnace 5 can be provided for preheating the deionized water discharged from the cooler 3 through a passage 80 and for introducing the water into the mixer 1. In addition, a decompressor 7 and a concentrator 8 can be provided behind the cooler 3.

The decompressor 7 decreases the high pressure of the product mixture supplied through a passage 100 to a low pressure of 1-40 bars.

The concentrator 8 concentrates the fluid containing the cathode-active material supplied through a passage 110. The concentrator 8 can adopt a method which passes only liquid phase materials by using a filter.

The electrode-active material prepared by the process of the present invention can be a stoichiometric compound or a nonstoichiometric compound. Examples of the electrode-active materials are a cathode-active material and an anode-active material of a secondary battery. Examples of cathode-active materials of secondary batteries can be classified into oxides and non-oxides. Depending on their structures, the oxide materials can be divided into olivine structure (e.g., LiMₓO₄), layered structure (e.g., LiMO₂), spinel structure (e.g., LiM₂O₄), nasicon structure (e.g., Li₃M₂(XO₄)₃), etc. (M is an element selected from the group consisting of the transition metals and the alkali metals or is a combination of at least two elements selected therefrom). The average particle size of cathode-active materials can be 50 nm to 5 μm.

From after the time when the raw materials of the electrode-active materials react under a supercritical environment until the time the reaction products move out of the subcritical region by passing through subsequent steps, the flow of the fluid is preferably not against the direction of gravity, that is, the fluid preferably flows in a horizontal direction or flows from a upper side to a lower side.

In the present invention, during the preparation process of the electrode-active material, the fluid in the reactor has a Reynolds number (N_{Re}) equal to or larger than 100,000, the turbulent kinetic energy “k” can be 0.02-1.5 m²/s², and the turbulent dissipation ratio “ε” can be 0.25-4 m²/s³.

The Reynolds number (Re) is a dimensionless number that gives a measure of the ratio of inertial force to viscous force and quantifies the relative importance of these two types of force for given flow conditions. The Reynolds number (N_{Re}) is defined by formula 1.

$${N}_{Re} = \frac{ρ {v}_{s}^{2} / L}{μ {v}_{s} / {L}^{2}} = \frac{ρ {v}_{s} L}{μ} = \frac{{v}_{s} L}{ν} = \frac{Inertial force}{Viscous force} \qquad ( 1 )$$

(where Vₛ is the average speed of flow, L is the characteristic length, μ is the viscosity coefficient of fluid, v is the kinematic viscosity coefficient, and ρ is the density of fluid.)

Ordinarily, if the Reynolds number is N_{Re}≦2,100, a laminar flow occurs; if the Reynolds number is 2,100<N_{Re}<4,000, a transition flow occurs, and if the Reynolds number N_{Re}≧4,000, a turbulent flow occurs. In the preparation of a cathode-active material according to the present invention, the fluid in the reactor preferably has a turbulent flow wherein the Reynolds number N_{Re} is equal to or larger than 100,000. If the Reynolds number of the fluid is less than 100,000, solid particles contained in the fluid can easily precipitate in the apparatus, e.g., due to difference in density between the fluid and the particles in the fluid and due to the scaling of ions existing in the process.

The turbulent kinetic energy “k” and the turbulent dissipation factor ε represent the strength of turbulent flow behavior. Since they are energies which can deagglomerate crystallized cathode-active materials by the rotational speed of eddies in the fluid flow, the turbulent kinetic energy and the turbulent dissipation factor are important in particle formation.

The turbulent kinetic energy “k” and the turbulent dissipation factor ε are obtained from the Navier-Stroke equation.

The reactor used in the present invention is not limited; however, a tubular reactor is preferred.

The density of the fluid in the reactor can be 150-450 kg/m³, and the viscosity can be 3.06×10⁵-5.26×10⁵ Pa·s.

In addition, the present invention may prevent plugging by having a double-pipe type heat exchanger at the rear of the reactor which generates a cathode-active material of a secondary battery.

The fluid in the double-pipe type heat exchanger can have a density of 413-703 kg/m³ and a viscosity of 4.85×10⁵-8.36×10⁵ Pa·s.

The fluid in the double-pipe type heat exchanger has a Reynolds number of 100,000 or greater. Turbulent kinetic energy can be 0.02-1.5 m²/s², and the turbulent dissipation factor ε can be 0.5-45 m²/s³.

The mixer for the raw materials of a cathode-active material, the reactor for generating the cathode-active material, and the cooler may all be a pipe type. In the case of a pipe type, the inner diameter of the pipe preferably remains unchanged or slowly decreases along the direction of the fluid flow, so that the inner surface of the pipe has a slow slope, preventing the formation of dead zones in the fluid flow. Referring to FIGS. 1, 2 and 3, the angle θ of the inner surface of the pipe can be 110° or greater and is preferably equal to or larger than 140°.

As shown in FIG. 1, if steps are formed at the inner diameter of the pipe, dead zones can easily be formed, and, consequently, solid components contained in the fluid passing through the pipe easily accumulate on the stepped portions, causing plugging.

In contrast, if the pipe has a uniform diameter as shown in FIG. 2, or if it has a slowly and gradually decreasing diameter as shown in FIG. 3, dead zones are not formed easily.

The present invention is explained by using the following examples.

### EXAMPLE 1

An explanation is made by referring to FIG. 6.

The raw materials of LiFePO₄, supplied through the passage 10, and water in its supercritical state were mixed in the mixer 1 and produced a slurry containing a precursor of LiFePO₄. The slurry was introduced into the reactor 2 in a supercritical environment at a temperature of 386° C. and a pressure of 250 bars, where LiFePO₄ was synthesized, and the resultant product of the synthesis was supplied to the double-pipe type heat exchanger 3 through the passage 30 and cooled.

As the reactor 2, pipes were used and the inner diameter of the pipes remained unchanged at the connecting portion between the reactor 2 and the mixer 1, the outlet of the reactor, the portion connecting with the heat exchanger's nozzles, and each portion of the reactor. The fluid in the reactor 2 had a density of 270 kg/m², a viscosity of 3.57×10⁻⁵ Pa·s, and a Reynolds number N_{Re} of 754,000, a kinetic energy of 0.032 m²/s², and a turbulent dissipation factor ε of 1.457 m²/s³.

The fluid in the passage 30, before it passed through the double-pipe type heat exchanger 3, was in the supercritical state, and the fluid in the passage 40 after it passed through the double-pipe type heat exchanger had a temperature of 360° C. and a pressure of 250 bars.

The fluid containing the cathode-active material in the passage 40 was introduced into the secondary heat exchanger 4 of the shell and tube type and cooled to 200° C. by the secondary heat exchanger 4. At this time, a cooling fluid supplied through the passage 60 was used, and the cooling water discharged from the secondary heat exchanger 4 was supplied to the double-pipe type heat exchanger 3 through the passage 70. The fluid containing LiFePO₄ and having a pressure of 250 bars and a temperature of 200° C. was supplied to the third heat exchanger 6 through the passage 50 and cooled to 40-80° C., and the thus-obtained material was processed so that its pressure was decreased to 30 bars using the decompressor 7, and the material was concentrated until the particles of LiFePO₄had a high concentration of 20 wt %, thus preparing a cathode-active material. Here, the average particle size of the cathode-active material was 270 nm.

The flow of the fluid from the mixer 1 to the third cooler 6 was controlled not to flow in the direction opposite to the direction of gravity.

As shown in FIG. 4(b), plugging did not occur at the reactor 2, and a stable and continuous process operation was possible for 100 consecutive hours.

### COMPARATIVE EXAMPLE 1

LiFePO₄ was prepared under the same conditions as in example 1 except that the pipe as shown in FIG. 1 was used as the reactor 2.

Plugging took place in the reactor 2 after 4-6 hours of operation, necessitating the repeated stops and restarts of the process operation. FIG. 5(a) shows the plugging in the reactor of comparative example 1.

### COMPARATIVE EXAMPLE 2

LiFePO₄ was prepared under the same conditions as in example 1 except that a shell and tube type was used as the heat exchanger 3. The fluid containing a cathode-active material had a density of 452 kg/cm³ and a viscosity of 5.23×10⁻⁵ Pa·s when it was introduced into the heat exchanger, and the fluid containing cathode-active material had a density of 655 kg/cm³ and a viscosity of 7.69×10⁻⁵ Pa·s when it was discharged from the heat exchanger 3.

Plugging took place in the heat exchanger 3 in the supercritical and subcritical regions after 6-8 hours of operation, so that the process operation had to be repeatedly stopped and restarted.

If an electrode-active material is continuously prepared according to the present invention, plugging and scaling can be suppressed in the course of the process, which enables a stable and continuous process operation, decreases the maintenance cost of the process, and extends the service life of the process facility. In addition, the electrode active material manufactured by the present invention has an increased crystallinity of particles, so the service life of batteries can be prolonged.

The present invention can be used for the preparation of electrode-active materials, cathode-active materials for secondary batteries, and especially for the electrode-active material LiFePO₄.

1. An apparatus for preparing an electrode-active material, comprising:
a reactor which produces an electrode-active material by using a supercritical hydrothermal synthesis method; and
a double-pipe type heat exchanger which cools the product discharged from the reactor to a subcritical range or below it.

2. The apparatus of claim 1, wherein the region from the reactor to the double-pipe type heat exchanger consists of pipes whose inner surface has an inclination angle θ of 110° or greater.

3. The apparatus of claim 1, wherein the region from the reactor to the double-pipe type heat exchanger consists of pipes whose inner surface has an inclination angle θ of 140° or greater.

4. The apparatus of claim 1, wherein the double-pipe type heat exchanger consists of pipes whose inner diameter is uniform.

5. The apparatus of claim 1, wherein the fluid passing through the double-pipe type heat exchanger flows in the direction of gravity.

6. The apparatus of claim 1, wherein the electrode-active material is a cathode-active material for a secondary battery.

7. The apparatus of claim 1, wherein the electrode active material is LiFePO₄.

8. A method for continuously preparing an electrode-active material, comprising:
a step of forming the electrode-active material by using a supercritical hydrothermal synthesis method; and
a step of cooling a fluid containing the electrode-active material to a subcritical range or below it by using a double-pipe type heat exchanger.

9. The method of claim 8, wherein the fluid in the double-pipe type heat exchanger has a Reynolds number of equal to or larger than 100,000, a turbulent kinetic energy of 0.02-1.5 m²/s², and a turbulent dissipation factor ε of 0.5-45 m²/s³.

10. The method of claim 8, wherein the fluid in the double-pipe type heat exchanger has a density of 413-703 kg/m³ and a viscosity of 4.85×10⁻⁵-8.36×10⁻⁵Pa·S.

11. The method of claim 8, wherein the supercritical hydrothermal synthesis method uses a reactor which has a temperature of 375-450° C. and a pressure of 230-300 bars.

12. The method of claim 8, wherein the average particle size of the 9 electrode active material is 50 nm to 5 μm.
